(19) United States
(12) Patent Application Publication
(10) Pub. No.: US 2006/0235742 A1
(43) Pub. Date: Oct. 19, 2006

(54) System and method for process evaluation

(76) Inventors: Maria Guadalupe Castellanos, Sunnyvale, CA (US); Fabio Casati, Palo Alto, CA (US); Ming-Chien Shan, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/108,515

(22) Filed: Apr. 18, 2005

(51) Int. Cl. G06F 17/30

(52) U.S. Cl. 705/10

(57) ABSTRACT

A method, apparatus, and system are disclosed for process evaluation. In one exemplary embodiment, a method for process evaluation includes accessing, with a computer, a set of process quality metrics; categorizing, with the computer, a set of processes based on the set of process quality metrics; and identifying, with the computer, a process from the set of processes that has a predefined set of values for the process quality metrics.

### BACKGROUND

Web services and service-oriented web architectures facilitate application integration within and across business boundaries so different e-commerce entities communicate with each other and with clients. As web service technologies grow and mature, business-to-business (B2B) and business-to-consumer (B2C) transactions are becoming more standardized. This standardization enables different service providers to offer customers analogous services through common interfaces and protocols.

In some e-commerce transactions, a business or customer selects from several different service providers to perform a specified service. For instance, an online retail distributor may select one or more shipping companies to ship products. The service providers (example, shipping companies) define parameters that specify the cost, duration, and other characteristics of various shipping services (known as service quality metrics). Based on the service quality metrics provided by the service provider, the customer selects a shipper that best matches desired objectives or needs of the customer.

Selecting different service providers based on service quality metrics provided by the service provider is not ideal for all web service processes. In some instances, the service quality metrics do not sufficiently satisfy the objectives of the customer since the service provider, and not the customer, defines the service quality metrics. For example, the service provider can be unaware of present or future needs of the customer. Further yet, the value of each service quality metric is not constant over time, and the importance of different metrics can change or be unknown to the service provider. For example, a shipping company may not appreciate or properly consider the importance to the customer of having products delivered on time to a specific destination.

Selecting different service providers creates additional challenges for web services that require composite services for various stages in the execution of a process, especially if the service provider provides the service quality metrics for the customer. For example, in a multi-stage process, a customer can require a first service provider to perform manufacturing or assembly, a second service provider to perform ground shipping, a third service provider to perform repair or maintenance, etc. Each stage in the execution of the process is interrelated to another stage, and each service provider can be independent of the other service providers. In some instances, the first service provider is not aware of service quality provided by the second or third service providers. As such, the customer can receive inefficient and ineffective services.

### BRIEF DESCRIPTION OF THE DRAWINGS

FIG. 1 is one exemplar embodiment of a block diagram of a system in accordance with the present invention.

FIG. 2 is one exemplar embodiment of a flow diagram in accordance with the present invention.

FIG. 3 is one exemplar embodiment of a block diagram of a service selection system in accordance with the present invention.

FIG. 4 is one exemplar embodiment of a classification model, corresponding to the second stage in FIG. 5, showing a stage tree for ranking shipping service providers in accordance with the present invention.

FIG. 5 is one exemplar embodiment of the order fulfillment process and the stages where service selection is performed with their corresponding stage trees in accordance with the present invention.

FIG. 6 is one exemplar embodiment of a flow diagram showing generation of service selection models in accordance with the present invention.

FIG. 7 is one exemplar embodiment of a flow diagram showing application of service selection models in accordance with the present invention.

### DETAILED DESCRIPTION

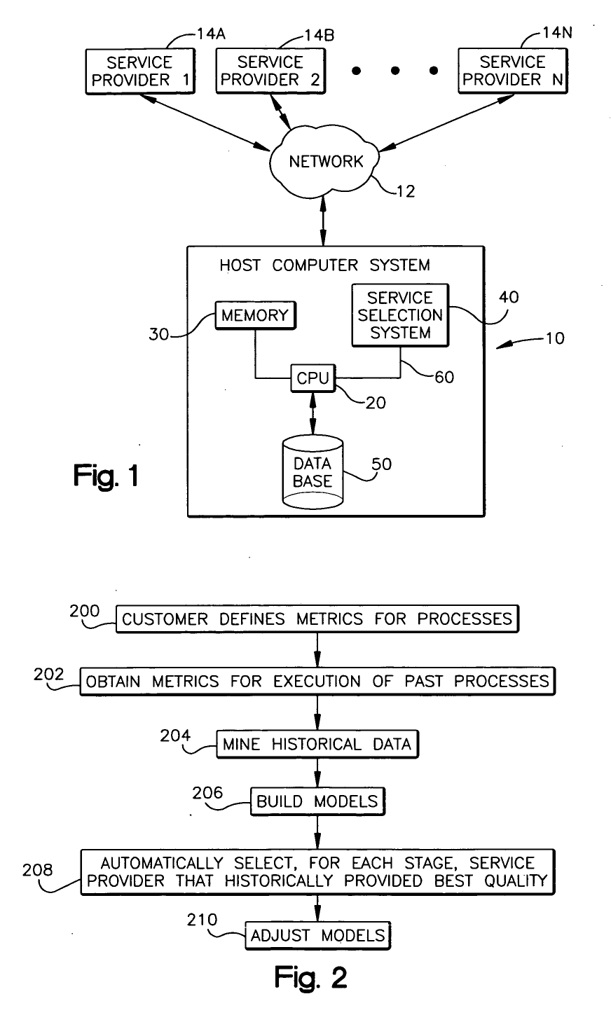

Exemplary embodiments in accordance with the present invention are directed to systems, methods, and apparatus for process evaluation. One exemplary embodiment includes service provider selection in composite web services. Exemplary embodiments are utilized with various systems and apparatus. FIG. 1 illustrates one such exemplary embodiment as a system using composite web services.

FIG. 1 illustrates a host computer system 10 in communication, via a network 12, with a plurality of service providers 14A, 14B, . . . 14N. The Host computer system 10 comprises a processing unit 20 (such as one or more processors of central processing units, CPU) for controlling the overall operation of the computer, memory 30 (such as random access memory (RAM) for temporary data storage and read only memory (ROM) for permanent data storage), a service or service provider selection system 40 (discussed in connection with FIGS. 2-7), and a non-volatile data base or data warehouse 50 for storing control programs and other data associated with host computer system 10. The processing unit 20 communicates with memory 30, data base 50, service selection system 40, and many other components via buses 60.

In some embodiments, the computer system includes mainframe computers or servers, such as gateway computers and application servers (which access a data repository). In some embodiments, the host computer system is located a great geographic distance from the network 12 and/or service providers 14. Further, the computer system 10 includes, for example, computers (including personal computers), computer systems, mainframe computers, servers, distributed computing devices, and gateway computers, to name a few examples.

The network 12 is not limited to any particular type of network or networks. The network, for example, includes a local area network (LAN), a wide area network (WAN), the internet, an extranet, an intranet, digital telephony network, digital television network, digital cable network, various wireless and/or satellite networks, to name a few examples.

The host computer system 10, network 12, and service providers 14 interact to enable web services. As used herein, the term “web services” means a standardized way to integrate various web-based applications (a program or group of programs that include systems software and/or applications software). Web services communicate over a network protocol (example, Internet protocol backbone) using various languages and protocols, such as XML (Extensible Markup Language used to tag data), SOAP (Simple Object Access Protocol used to transfer the data over the network), WSDL (Web Services Description Language used to describe available services), and UDDI open standards (Universal Description Discovery Integration used to list available services). Web services enable B2B and B2C network based communication without having specific knowledge of the IT (Information Technology) systems of all parties. In other words, web services enable different applications from different sources (customers, businesses, etc.) to communicate with each other via a network even if the web services utilize different operating systems or programming languages.

FIG. 2 shows a flow diagram of an exemplary embodiment utilized with the system of FIG. 1. With respect to block 200, a process owner (user or customer) defines quality goals or objectives of his business processes. These goals and objectives are metrics (such as service quality metrics) that are provided for each process and/or various stages or steps in composite web services. As used herein, a “business metric” or “service quality metric” (“metric” in general) is any type of measurement used to gauge or measure a quantifiable component or measurement of performance for a customer, company, or business. Examples of metrics include, but are not limited to, time, costs, sales, revenue, return on investment, duration, goals of a business, etc. Data on metrics includes a wide array of applications and technologies for gathering, storing, computing, and analyzing data to assist enterprise users in making informed business decisions, monitoring performance, achieving goals, etc.

The process owner also defines an execution, such as specifying which executions are most important or have the highest and lowest quality. For example, a process owner specifies function over process execution data that labels process executions with quality measures. As a simple example, a process owner specifies execution of a process as having a high quality if the process completes within five days and has a cost of less than $50. Alternatively, process owners explicitly label executions that are based on, for example, customer feedback.

With respect to block 202, service quality metrics values (i.e., measurements) are obtained or accessed from execution data of prior or historical processes. Historical metric data is stored (example, in database 50 of FIG. 1) for subsequent retrieval and analysis. In one embodiment, such historical data is raw data (example, data that has been collected and stored in a database but not yet formatted or analyzed).

With respect to block 204, the historical data is prepared and mined. Various data mining techniques are used to analyze the historical data. Data mining includes, for example, algorithms that analyze and/or discover patterns or relationships in data stored in a database.

With respect to block 206, data mining of the historical data is used to build one or more models. In one exemplary embodiment, the historical data is categorized to build the models. With respect to block 208, the models automatically identify or select (example, without human intervention) the service provider that historically (example, in analogous situations) has contributed to high quality processes with respect to the service quality metrics of the process owner. In other words, the system, utilizing the models, determines for each stage or step during execution of the process which service provider is best suited or matched to provide services to the process owner for the particular stage with respect to the process owner defined metrics. As used herein, a “step” or “stage” is a path followed by a process execution up to a given process activity.

With respect to block 210, the models are adjusted or re-learned. In one exemplary embodiment, the models are relearned when their accuracy diminishes, periodically or every time new data is loaded into the data warehouse The models, for example, are adjusted or re-learned during, before, or after execution of various stages of the processes. Adjustments or re-learning are based on a myriad of factors. By way of example, adjustments or re-learning are based on changing behavior or performance of service providers (example, new information not previously considered or implemented in the models). New or updated historical data is also used to update the models. Additionally, adjustments or re-learning are based on modified service quality metrics of the process owner (example, changes to the metrics to redefine or amend objectives for the business process). Models are adjusted or re-learned to provide a more accurate selection or ranking of the service providers for a given process or stage in the process.

Embodiments in accordance with present invention operate with minimal user input. Once the process owner defines the service quality metrics, the service providers are automatically selected (example, selected, without user intervention, by the host computer system 10 of FIG. 1). Such automatic selection is based, in part, on identifying the relevant context partitions and the services that should be selected based on the process execution context. As used herein, “context” refers to specific characteristics of each process execution. Preferably, exemplary embodiments utilize models built from historical data. The models are either re-learned from scratch or progressively adjusted to reflect, for example, changing notions of process quality metrics as well as changing behavior or performance information of service providers. For example, the models are continuously adjusted/altered or periodically adjusted/altered to include newly acquired or not previously utilized historical data. As used herein, “periodic” refers to occurring or recurring at regular intervals. In one embodiment, such adjustments are automatically performed with a computer in real-time (i.e., occurring immediately and/or responding to input immediately).

Thus, the flow diagram of FIG. 2 provides a method for which a computer selects a service provider at a given instant in time or at a given process stage during execution of a composite web service (i.e., while the process is executing), but before completion or termination of execution of the service. The selection is based on past performance of each service provider with respect to the metrics of the process owner or customer. Data mining techniques are used to find patterns in the historical data to compute the selection. Further, such selection is dynamic (i.e., mining models are applied at the moment in time when a selection needs to be performed). Preferably, the mining models are executed during the process (i.e., a-posteriori: applied on current observed facts). In one embodiment, for each composite service execution and for each step/stage in the execution, a service provider is selected that maximizes a probability of attaining, satisfying, matching, and/or optimizing the service quality metrics previously defined by the user.

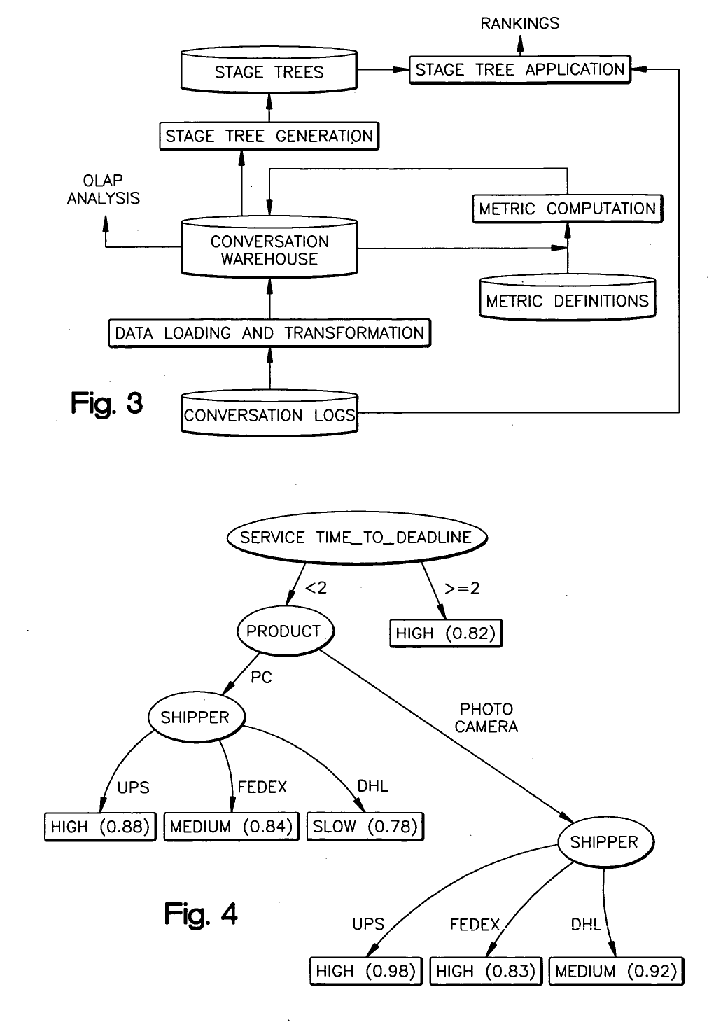

Reference is now made to FIGS. 3-7 wherein exemplary embodiments in accordance with the present invention are discussed in more detail. In order to facilitate a more detailed discussion, certain terms, nomenclature, and assumptions are explained.

Generally, exemplary embodiments improve the quality of a service S that a service provider SP offers, at the request of a process owner PO, to a customer C. In order to deliver S, the provider SP executes a process P that invokes operations of service types ST₁, ST₂, . . . ST_{N}. In the context of web services and as used herein, the term “composite service” refers to a process or transaction implemented by invoking other services or by invoking plural different services. The term “composite web service” refers to a process or transaction implemented over a network (such as the internet) by invoking other services or by invoking plural different services. Further, as used herein, the term “service type” refers to a functionality offered by one or more service providers. A service type can be, for example, characterized by a WSDL interface, or a set of protocols (example, business protocols, transaction protocols, security protocols, and the like). A service type can also be characterized by other information, such as classification information that states which kind of functionality is offered. As used herein, the term “service” refers to a specific endpoint or URI (Uniform Resource Identifier used for various types of names and addresses that refer to objects on the world wide web, WWW) that offers the service type functionality Each service provider offers each service at one or more endpoints. For purposes of this description, each service provider offers each service at only one endpoint (embodiments in accordance with the invention, though, are not limited to a single endpoint but include service providers that offer multiple endpoints). As such, selecting the endpoint or the service provider for a given service type is in fact the same thing. As used herein and consistently with the terminology used in the web services domain, a “conversation” is a message exchange or set of message exchanges between a client and a service or service provider. Further, for purposes of this description, each interaction between C and S and between S and the invoked services S₁, S₂, . . . S_{N} occurs in the context of a conversation CV. Regardless of the implementation of the composite web service, it is assumed that the supplier has deployed a web service monitoring tool that captures and logs all web services interactions, and in particular all conversations among the supplier and its customers and partners.

The particular structure of the conversation logs widely varies and depends on the monitoring tool being used. By way of example, the structure of the conversation logs include: protocol identifier (example, RosettaNet PIP 314), conversation ID (identification assigned by a transaction monitoring engine, example OVTA: OpenView Transaction Analyzer used to provide information about various components within the application server along a request path), parent conversation ID (null if the conversation is not executed in the context of another conversation), and conversation initiation and completion time. Further, every message exchanged during the conversation can include WSDL operation and message name, sender and receiver, message content (value of the message parameters), message timestamp (denoting when the message was sent), and SOAP header information.

Once conversations logs are available, users (example, process owners) define their quality criteria (metrics or service quality metrics) over the process (conversation) executions. By way of example, the service provider defines which conversations have a satisfactory quality with respect to the objectives of the service provider. With this information, the system computes quality measures. The quality measures, in turn, are input to the “intelligent” service selection component to derive context-based service selection model.

In one exemplary embodiment, process owners define process quality metrics as functions defined over conversation logs. In general, these functions are quantitative and/or qualitative. For example, quantitative functions include numeric values (example, a duration or a cost); and qualitative functions include taxonomic values (example, “high”, “medium”, or “low”).

Regardless of the specific metric language and its expressive power, metrics are preferably computable by examining and/or analyzing the conversation logs. As such, a quality level is associated to any conversation.

Once a notion of quality is defined, process owners define a desired optimized service selection. For example, the service selection is a quantitative selection, and/or a qualitative selection. Quantitative selections identify services that minimize or maximize an expected value of the quality metric (example, the expected cost). By contrast, qualitative selections identify services that maximize a probability that the quality is above a certain threshold (example, a cost belongs to the “high quality” partition that corresponds to expenditures less than $ 5000.00).

Once quality criteria are defined, a Process Optimization Platform (POP) computes quality metrics for each process execution. FIG. 3 illustrates an exemplary service selection subsystem of POP. As used herein, a “platform” describes or defines a standard around which a system is based or developed (example, the underlying hardware and/or software for a system).

In one exemplary embodiment, quality metric computation is part of a larger conversation data warehousing procedure. The warehousing procedure acquires conversation logs, as recorded by the web service monitoring tool, and stores them into a warehouse to enable a wide range of data analysis functionality, including in particular OLAP-style analysis (Online Analytical Processing used in data mining techniques to analyze different dimensions of multidimensional data stored in databases). Once data are warehoused, a metric computation module executes the user-defined functions and labels conversation data with quality measures.

In addition to the generic framework for quality metrics described above, POP includes a set of built-in functions and predefined metrics that are based on needs or requirements of customers. As an example, customer needs include associating deadlines to a conversation and/or defining high quality conversations as those conversations that complete before a deadline. This deadline is either statically specified (example, every order fulfillment must complete in five days) or varied with each conversation execution, depending on instance-specific data (example, the deadline value is denoted by a parameter in the first message exchange). When deadlines are defined, POP computes and associates three values to each message stored in the warehouse. These three values include: (1) the time elapsed since the conversation start, (2) the time remaining before the deadline expires (called time-to-deadline, and characterized by a negative if the deadline has already expired), and, (3) for reply messages only, the time elapsed since the corresponding invoke message was sent.

The purpose of context-specific and goal-oriented service ranking is to determine which service provider performs best within a given context, such as a conversation that started in a certain day of the week by a customer with certain characteristics. Ranking refers to defining a relative ordering among services. The ordering depends on the context and on the specific quality goals (i.e., service quality metrics). Once ranking information is available, the system performs service selection in order to achieve the desired goals or metrics. For example, the system picks the available service provider with the highest rank among all existing available service providers.

Data warehousing and data mining techniques are applied to service execution data, and specifically conversation data, in order to analyze the behavior or prior performance of services and service providers. In particular, data mining techniques are used to partition the contexts. The data mining techniques are also used to identify ranking for a specific context and for each step or stage in the process in which a service or service provider needs to be selected.

POP mines conversation execution data logged at the PO's site to generate service selection models. The service selection models are then applied during the execution of process P.

Various classification models or schemes are used with data mining techniques. These models group related information, determine values or similarities for groups, and assign standard descriptions to the values for practicable storage, retrieval, and analysis. As one example, decision trees are used with data mining. Decision trees are classification models in the form of a tree structure (example, FIG. 4). The tree includes leaf nodes (indicating a value of the target attribute) and decision nodes (indicating some test to be carried-out or performed on an attribute value). In one exemplary process, the classification process starts at the root and traverses through the tree until a final leaf node (indicating classification of the instance) is reached. Specifically, objects are classified by traversing the tree, starting from the root and evaluating branch conditions (decisions) based on the value of the attribute of the object until a leaf node is reached. Decisions represent a partitioning of the attribute/value space so that a single leaf node is reached. Each leaf in a decision tree identifies a class. Therefore, a path from the root to a leaf corresponds to a classification rule whose antecedent is composed by the conjunction of the conditions in each node along the path and whose consequent is the corresponding class at the leaf. Leaf nodes also contain an indication of the accuracy of the rule (i.e., probability that objects with the identified characteristics actually belong to that class).

Various methods, such as decision tree induction, are used to learn or acquire knowledge on classification. For example, a decision tree is learned from a labeled training set (i.e., data including attributes of objects and a label for each object denoting its class) by applying a top-down induction algorithm. A splitting criterion determines which attribute is the best (more correlated with classes of the objects) to split that portion of the training data that reaches a particular node. The splitting process terminates when the class values of the instances that reach a node vary only slightly or when just a few instances remain.

POP uses decision trees to classify conversations based on their quality level. These classifications are then used to perform service ranking. Hence, conversations are the objects to be classified, while the different quality categories (example, high, medium, and low) are the classes. These decision trees are conversation trees. Hence, in conversation trees, the training set is composed of the warehoused conversation data and the metrics computed on top of it (such as the time-to-expiration metric). The label for each conversation is a value of the metric selected as quality criterion. For example, for a cost-based quality metric, each executed conversation is labeled with a high, medium or low value, computed according to the implementation function of the metric. The training set is then used to train the decision tree algorithm to learn a classification model for that metric.

The structure of the decision tree represents a partitioning of the conversation context according to patterns that in the past have typically led to or provided specific values of the given quality metric (see FIG. 4). The different patterns mined from context data are identified by traversing the paths from the root to each leaf node such that classifications of conversations are based on corresponding attributes.

In some exemplary embodiments, conversation trees generate service ranking and selection. For example, dynamic service selection is divided based on when the selection is performed. One option is to select all services at the start of a new conversation (example, selecting the warehouse and the shipper at the start of the conversation of an order fulfillment process). Another option is to select services as and when needed (example, selecting the shipper when the shipping service is actually needed). In one exemplary embodiment, the latter option is utilized since the decision is taken later in the conversation and, hence, later in the process when more contextual information is available. In one exemplary embodiment, services are selected after execution of the process commences but before execution of the process completes. For example, if the shipper is selected when needed, the information on which warehouse has been chosen (example, the warehouse location) as well as information on the time left before the process deadline expires is used to determine the best service provider to be selected.

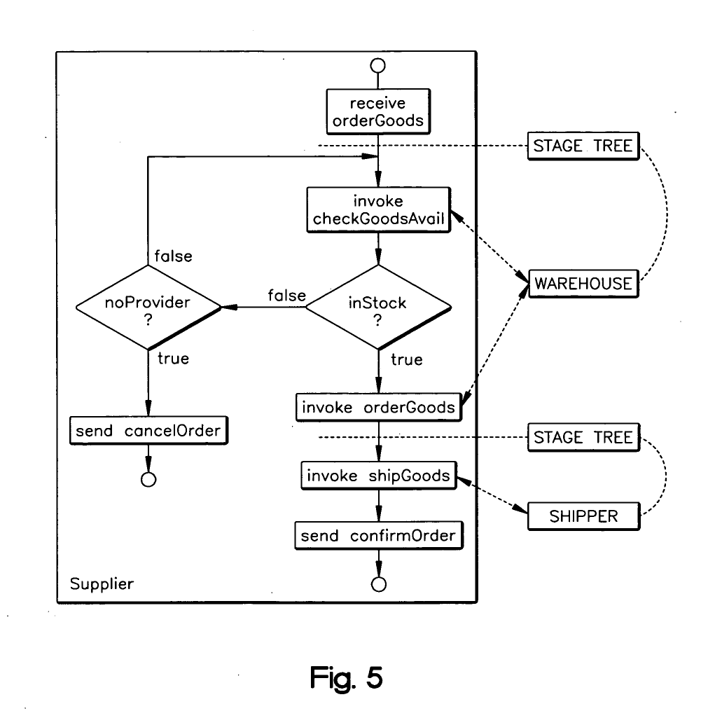

As noted, conversation trees compute service selection during execution of the process at a time when the service selection is needed or requested. POP computes or generates a conversation tree for each stage of the process at which a selection of a service has to be performed. In the example shown in FIG. 5, two stages exist: (1) before the execution of the invoke CheckGoodsAvail activity, where a service of type WarehouseOrderST must be selected, and (2) before the execution of the invoke shipGoods activity, where a service of type ShipGoodsST must be selected. These stage-specific conversation trees (or stage trees) are built using data about past or historical conversation execution. However, only data corresponding to messages exchanged up-to-the point the stage is reached is included in the training set. In addition, the service provider that was selected for that stage in each conversation is also included since the stage tree determines how each service provider contributes to the conversation quality in each given context. Hence, the classification models include service providers as splitting criteria.

Looking to FIG. 5, the first tree corresponds to a stage where only the receive orderGoods step has been executed. Two criteria are used to build this first tree: the service provider selected for the WarehouseOrderST service type, and only data from the initial orderGoods message that the customer has sent to the supplier. The second tree corresponds to the stage where a shipping company is selected for service type shippingST. Three criteria are used to build this second tree: the provider of shippingST, data from messages exchanged as part of the conversation between supplier S and the warehouse, and data from the orderGoods message that the customer has sent to the supplier.

In some exemplary embodiments, only certain conversation attributes are utilized when building the trees, while other conversation attributes are excluded. In these embodiments, the generated trees include only those attributes in their splitting criteria.

FIG. 4 illustrates a simplified tree that corresponds to the second tree in FIG. 5. In FIG. 4, different paths correspond to different contextual patterns. The tree classifies conversations based on a quality metric whose definition includes a mix of cost and time-based conditions. Specifically, the conversation should complete within its deadline and the cost should be lower than $5,000. As illustrated, the path from the root to the leftmost leaf of the tree shows that shipping provider UPS (United Parcel Service) is a good candidate for shipping PCs (personal computers) when the deadline is approaching, given that it contributes to obtain a high quality level in this context. This pattern is stated as the following rule:
IF time-to-deadline<2 and product=“PC” and shipper=“UPS” THEN quality-level=“High” with probability 0.8.

In order to compute stage trees, POP collects conversation execution data from the warehouse (FIG. 3) and then selects conversation attributes that are based on heuristics correlated with typical process metrics. Next, the prepared data is fed to a data mining algorithm that generates the trees stored in a database. This procedure is executed periodically without interfering with (example, does not slow down) process executions.

Once stage trees have been learned for the different stages where service selection is needed, they are used to rank service providers. POP offers at least two different methods of ranking depending on whether the ranking is qualitative or quantitative.

At the time service providers need to be ranked, the stage tree corresponding to the current stage is retrieved and applied to the current context. In one exemplary embodiment, the conversation data is used to assess the rules identified by the stage tree and hence to reach a leaf. For example, the stage tree is generated using conversation data corresponding to messages exchanged before that stage. Therefore, variables that appear in the splitting criteria of the decision tree are all defined. In some exemplary embodiments, the conversation end time is excluded from the splitting criteria, while in other embodiments the conversation end time is included. Further, in some exemplary embodiments, the information regarding the selected service provider is available for the historical conversations used to generate the stage tree.

After retrieving the stage tree and the data for the conversation of interest (i.e., the one to be classified), POP generates several test instances (the objects to be classified), one for each possible service provider. Here, the tree predicts what will happen (what will be the final process quality) if a certain provider is selected. At this stage, each test instance includes all the information required for the classification. Classification of the test instances enables identification of which instances result in high, medium, or low quality executions. Furthermore, each leaf of a stage tree has an associated confidence value representing the probability that the corresponding rule (path) is satisfied. As such, POP is aware of the probability of the final process result having a certain quality. In order to rank the service providers, the service providers are sorted according to the classification obtained for their respective test instances. As an example, sorting is provided as first those service providers with the highest quality level, then those service providers with next lower quality level, and so on. This process continues until service providers are identified with the lowest quality level. Inside each level, service providers are ranked by the probability associated to the classification of their corresponding test instances.

In this embodiment, the decision tree algorithms identify the most significant discriminators as splitting criteria. Consequently, the stage trees include the service provider as splitting criterion for some contexts (i.e., along some paths of the tree). Paths (from the root to a leaf node) where the service provider does not appear in any splitting criteria correspond to situations where the service provider is not a significant factor in the determination of the overall conversation quality in certain contexts. In this case, the service provider can be excluded in the generated rules derived from those paths of a stage tree. Alternatively, other selection criteria are used (example, least cost, shorter time, or other rankings based on quality parameters). For example, as shown in FIG. 4, the selection of a particular shipper is not a crucial factor if the time to deadline expiration is more than two days, as the overall quality is anyway likely to be high. Unlike tree generation, which is done offline, classification and ranking are dynamically performed for each process. Hence, POP takes conversation information directly off the “live” or “real-time” conversation logs (FIG. 3).

Maximizing the probability of meeting a quality level is one exemplary criterion for ranking. Other criteria are also within embodiments according to the invention. For example, other embodiments optimize one or more statistical values of the quality metric. For instance, a service provider is selected that is likely to contribute to a high quality level, as long as the minimum value of the underlying metric (example, the cost) is above (or not below) a certain value, and/or the average value of this metric is not the lowest.

POP applies the qualitative ranking (as explained above) and partitions the service providers based on the process quality level they are likely to generate. However, ranking of service providers within each quality level is then performed by computing a specified aggregate value of a metric for all training instances on each leaf, and by sorting providers based on that value. An example illustrates this ranking: When supplier S₁ is selected, the quality is high with 100% probability, as the cost value is always at $4,500 (below an amount of $5,000 that denotes high quality executions). When provider S₂ is selected, conversations have high quality with only 90% probability (the tree still classifies them as high quality), but on average the cost is $2,000. The conversations also have a higher variance, and this variance contributes to conversations having a low quality. A pure qualitative ranking would rank S₁ higher, while a cost-based quantitative approach would rank S₂ higher.

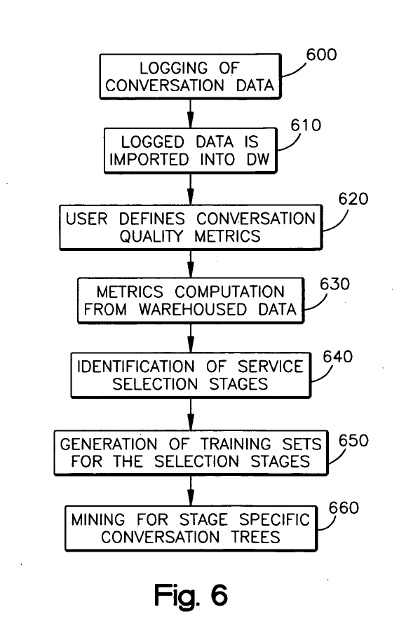

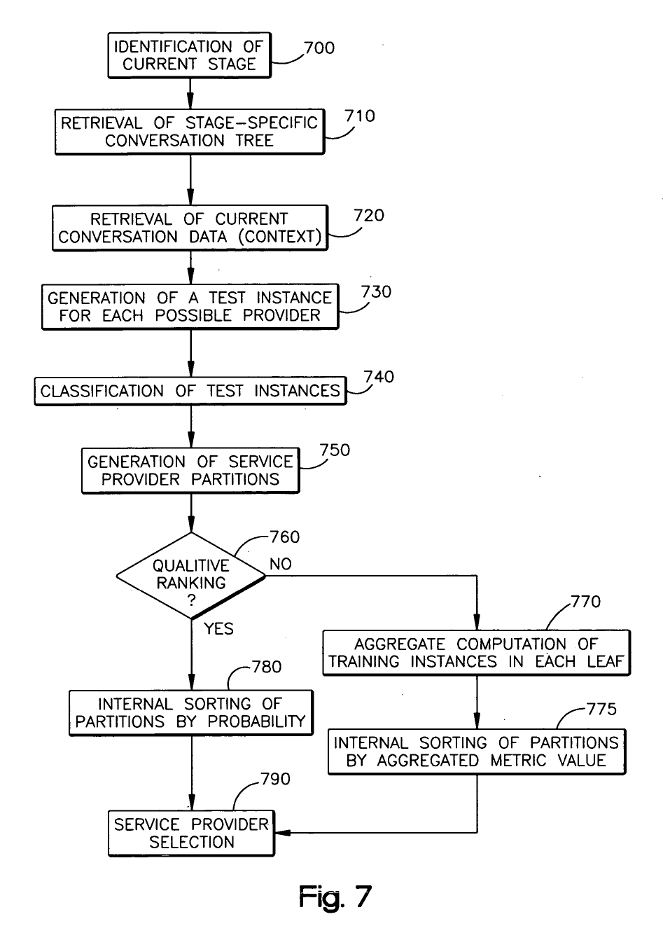

FIGS. 6 and 7 are flow diagrams of exemplary operations of the service selection component of POP. Specifically, FIG. 6 corresponds to the generation of the service selection models, and FIG. 7 corresponds to the application of such models for ranking.

Looking simultaneously to FIGS. 3 and 6, with respect to block 600, conversation data is logged. This data, for example, includes raw data about the service providers. With respect to block 610, the logged data is imported into the data warehouse (DW). The data passing into the data warehouse undergoes processing from a raw data state to a formatted state. Next, with respect to block 620, users (example, customers or process owners) define conversation quality metrics. As best shown in FIG. 3, the metric definitions are combined with the conversation warehouse data and input into the metric computation. Next, with respect to block 630, metrics are computed from the warehouse data. With respect to block 640, identification of service selection stages occurs. With respect to block 650, generation of training sets for the selection stages occurs. With respect to block 660, mining occurs for stage specific conversation trees.

FIGS. 3 and 7 illustrate how the models are used to generate ranking of the service providers. With respect to block 700, identification of a current stage or step in execution of the process occurs. Once the stage is identified, with respect to blocks 710 and 720, the stage-specific conversation tree and the current conversation data (context) are retrieved. As shown in block 730, a test instance is generated for each possible service provider. In one exemplary embodiment, the tests instances are generated at the point in time when the service provider is needed and utilizing conversation data that exist up to that point. Next, with respect to blocks 740 and 750, the test instances are classified by applying the stage tree on the test instances, and the service provider partitions are generated (i.e., classifications of service providers according to the quality expected). With respect to block 760, a query occurs: Is qualitative ranking desired? If the answer is “no” then, with respect to blocks 770 and 775, the system aggregates computation of training instances in each leaf, and internal sorting of partitions by aggregated metric value occurs. If the answer to the query is “yes” then, with respect to block 780, internal sorting of partitions by probability occurs. The flow diagram concludes at block 790 wherein the service provider is selected.

In one exemplary embodiment, the flow diagrams of FIGS. 6 and 7 are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

FIGS. 2, 6, and 7 provide flow diagrams in accordance with exemplary embodiments of,the present invention. The diagrams are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention

In the various embodiments in accordance with the present invention, embodiments are implemented as a method, system, and/or apparatus. As one example, the embodiment are implemented as one or more computer software programs to implement the methods of FIGS. 2, 6, and 7. The software is implemented as one or more modules (also referred to as code subroutines, or “objects” in object-oriented programming). The location of the software (whether on the host computer system of FIG. 1, a client computer, or elsewhere) will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory, and accessed by the processor using the bus. The techniques and methods for embodying software programming code in memory, on physical media, and/or distributing software code via networks are well known and will not be further discussed herein. Further, various calculations or determinations (such as those discussed in connection with FIGS. 1-7) are displayed (for example on a display) for viewing by a user. As an example, one the service providers are ranked, the rankings are presented on a screen or display to a user.

The above discussion is meant to be illustrative of the principles and various embodiments-of the present invention. Numerous variations and modifications will become apparent to those skilled in the art once the above disclosure is fully appreciated. It is intended that the following claims be interpreted to embrace all such variations and modifications.

What is claimed is:

1) A method for process evaluation, comprising:
accessing, with a computer, a set of process quality metrics;
categorizing, with the computer, a set of processes based on the set of process quality metrics; and
identifying, with the computer, a process from the set of processes that has a predefined set of values for the process quality metrics.

2) The method of claim 1, wherein the process is identified, without human intervention, for each of different stages in a business process that utilizes composite web services.

3) The method of claim 1, wherein the identified process provides a customer with web services according to the process quality metrics.

4) The method of claim 1, further comprising updating categorization of the set of processes based on historical data of plural service providers in order to rank the plural service providers and identify the process.

5) The method of claim 1, further comprising computing, with a decision tree, service selection of a selected service provider during execution of the process at a time when the service selection is needed.

6) The method of claim 1, wherein the process is quantitatively selected by identifying web services that provide an expected value of the process quality metrics.

7) A method for process evaluation, comprising:
storing metrics defining objectives for a business process using web service business-to-business communication;
recording conversation logs with a web service monitoring tool;
building a model from the recorded conversation logs to determine prior performance of plural different service providers; and
automatically selecting with a computer, while the business process executes and based on the model, a service provider from the plural service providers.

8) The method of claim 7 further comprising adjusting the model, during execution of the business process, based on one of (1) changes to the metrics to amend the objectives for the business process, or (2) additional performance information concerning the plural service providers, the additional performance information not previously implemented in the model.

9) The method of claim 7, wherein the business process is a composite service that invokes a plurality of different services from the plural service providers.

10) The method of claim 7 further comprising storing the conversation logs from web service interactions with the plural service providers and mining the conversation logs to build the model.

11) The method of claim 7 further comprising defining, from input from a user, the metrics to include quality criteria about the conversation logs from prior web service interactions between the user and the plural service providers.

12) The method of claim 7, wherein the model includes a decision tree to classify the conversation logs based on a quality level with respect to the metrics.

13) The method of claim 7, wherein building the model further comprises partitioning the conversation logs according to the objectives for the business process.

14) The method of claim 7, wherein the selected service provider is selected by identifying whether prior services of the selected service provider are above a threshold.

15) The method of claim 7 further comprising ranking the plural service providers to determine which service provider to select for a given context.

16) A computer system, comprising:
means for storing metrics defining objectives for a process that uses a network to conduct business-to-business transactions with plural different service providers;
means for mining data to build a model, the data including prior conversation logs with the plural service providers;
means for ranking the plural service providers based on the model and the metrics, the means for ranking determining relative ordering among the service providers, the ordering based on analysis of the metrics and the prior conversation logs for each service provider; and
means for automatically selecting, without user input and during execution of the process, a service provider having the objectives of the metrics.

17) The computer system of claim 16, wherein the means for mining includes at least one decision tree, and the conversation logs are objects to be classified in the decision tree.

18) The computer system of claim 16, wherein the process includes a plurality of services that invoke other services, and a service provider for a particular service is selected at an instant in time when the particular service is requested during execution of the process.

19) The computer system of claim 16, wherein the means for ranking determines which service provider to select based on the objectives of the metrics.

20) Computer code executable on a computer system, the computer code comprising:
code to store metrics, input from a user, that define objectives for a business process using web services over a network to conduct business-to-business communications with plural different service providers, the business process including a plurality of services that invoke other services;
code to mine historical data that includes prior conversation logs with the plural different service providers;
code to build a model, based on the mined historical data, that partitions the conversation logs according to desired values of the metrics of the user; and
code to automatically select, at a time when a particular service is requested during execution of the business process and based on the metrics and deployment of the model, a service provider from the plural service providers.

21) A computer system, comprising:
memory storing a service selection algorithm; and
at least one processor in communication with the memory for executing the service selection algorithm to:
store metrics, defined by a user, for a business process using composite web services;
mine historical data to build a model, the historical data including prior performance information of plural different service providers; and
select, after commencement of the business process and based on the model, a service provider from the plural service providers.
